(19) United States
(12) Patent Application Publication
(10) Pub. No.: US 2003/0210863 A1
(43) Pub. Date: Nov. 13, 2003

(54) Thermally compensated fiber bragg grating assembly

(76) Inventors: Jonathan E. Myers, Portland, OR (US); Duwayne R. Anderson, St. Helens, OR (US)

Correspondence Address: TEKTRONIX, INC., 14150 S.W. KARL BRAUN DRIVE, P.O. BOX 500 (50-LAW), BEAVERTON, OR, 97077-0001, US

(21) Appl. No.: 10/145,428

(22) Filed: May 13, 2002

(51) Int. Cl. G02B 6/34; G02B 6/00

(52) U.S. Cl. 385/37; 385/137

(57) ABSTRACT

A thermally compensated Fiber Bragg Grating (FBG) assembly has an FBG mounted on a substrate of a material having a very low coefficient of thermal expansion relative to that for the FBG so that the FBG is constrained to expand/contract at the very low coefficient of thermal expansion. In one form an optical fiber with the FBG somewhere in the middle is wrapped under tension around a spool as the substrate at a maximum operating temperature of the FBG assembly. The opposing ends of the optical fiber are attached to the spool so that the FBG is constrained to expand/contract in accordance with the CTE of the spool. Alternatively the FBG may be securely attached along its length on the substrate at a minimum operating temperature of the FBG assembly to constrain the FBG to expand/contract at the CTE of the substrate.

### BACKGROUND OF THE INVENTION

The present invention relates to Fiber Bragg Gratings, and more particularly to a thermally compensated Fiber Bragg Grating assembly.

A Fiber Bragg Grating (FBG) is a section of ordinary single-mode optical fiber that is modified to create periodic changes in the index of refraction. Such FBGs are used as optical filters and sensors. The thermal drift of a wavelength filtered by an FBG is directly proportional to the thermal expansion of the optical fiber. For use in precision applications elimination of the thermal drift is desired.

### BRIEF SUMMARY OF THE INVENTION

Accordingly the present invention provides a thermally compensated Fiber Bragg Grating (FBG) assembly where an FBG is constrained on a substrate of a material having a very low coefficient of thermal expansion relative to that of the FBG. A length of optical fiber containing the FBG may be wrapped under tension on a cylindrical spool as the substrate made of a material, such as a Super Invar™ material, that has a coefficient of thermal expansion (CTE) much lower than that of the optical fiber including the FBG. The wrapping is performed at a maximum operating temperature for the assembly, and the opposing ends of the optical fiber are fixed to the spool. In this way the optical fiber is constrained to expand/contract in accordance with the CTE of the spool. Alternatively the FBG may be attached linearly to the substrate along its entire length at a low temperature, also constraining the FBG to expand/contract in accordance with the CTE of the substrate.

The objects, advantages and other novel features of the present invention are apparent from the following detailed description when read in conjunction with the appended claims and drawing.

### BRIEF DESCRIPTION OF THE SEVERAL VIEWS OF THE DRAWING

FIG. 1 is a perspective view of a first embodiment of a thermally compensated Fiber Bragg Grating assembly according to the present invention.

FIG. 2 is a perspective view of a second embodiment of a thermally compensated Fiber Bragg Grating assembly according to the present invention.

### DETAILED DESCRIPTION OF THE INVENTION

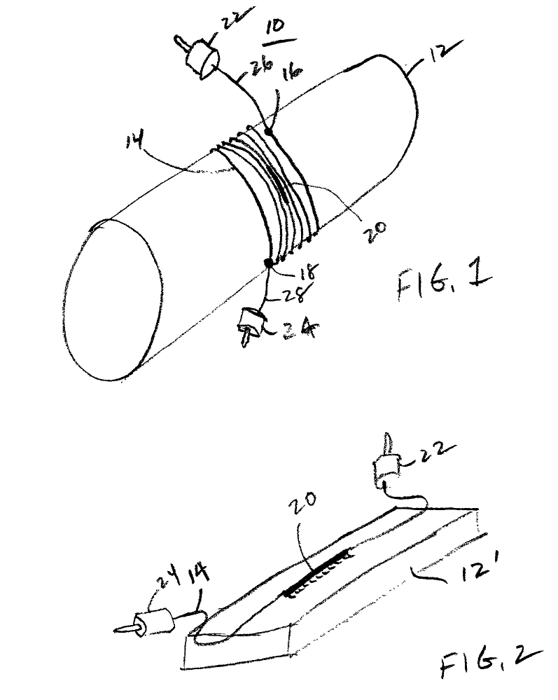

Referring now to FIG. 1 a thermally compensated Fiber Bragg Grating (FBG) 10 is shown having a substrate 12 in the form of a cylindrical spool of a material having a very low coefficient of thermal expansion material. The substrate may be made of a Super Invar™ material, which is an iron-nickel metal alloy with cobalt added that has nearly a zero coefficient of thermal expansion (CTE) over “room” temperatures—CTE˜0.63*10^{-6/K} where K=degrees Kelvin. An optical fiber 14 is wrapped around the spool 12 under tension and fixed to the spool at opposite ends 16, 18. An FBG 20 is located somewhere in the middle of the spool. At the fixed points 16, 18 appropriate fiber connectors 22, 24 are attached via short lengths of optical fiber 26, 28.

The tension put into the optical fiber 14 is picked such that at the maximum operating temperature the optical fiber has expanded so that it has tension in it. Since the CTE of the optical fiber 14 is much greater than the CTE of the spool, at any temperature below this maximum operating temperature the optical fiber 14 is constrained to expand/contract at the much lower CTE of the spool 12. This much lower CTE stabilizes the thermal drift of the wavelength filtered by the FBG 20 since the drift, as indicated above, is directly proportional to the thermal expansion of the optical fiber 14.

Alternatively as shown in FIG. 2 the FBG 20 may be mounted linearly on a substrate 12′ of the low CTE material at a low temperature below or at its minimum expected operating temperature, with the FBG being attached to the substrate along its entire length. In either configuration the FBG 20 is constrained to expand/contract at the CTE of the substrate 12′, stabilizing the thermal drift of the FBG. Although these configurations introduce stress (force/area) into the FBG 20, the optical properties are a function of strain or linear expansion (ΔI/L) which stays essentially constant.

Thus the present invention provides a thermally compensated Fiber Bragg Grating by constraining a Fiber Bragg Grating on a substrate of a material having a very low coefficient of thermal expansion relative to that of the Fiber Bragg Grating, the FBG being attached securely to the substrate so that the FBG expands/contracts at the much lower CTE of the substrate.

What is claimed is:

1. A thermally compensated Fiber Bragg Grating assembly comprising:
a substrate composed of a material having a very low coefficient of thermal expansion; and
a Fiber Bragg Grating mounted on the substrate such that the Fiber Bragg Grating is constrained to expand/contract in accordance with the very low coefficient of thermal expansion, the Fiber Bragg Grating having a coefficient of thermal expansion greater than that of the material of the substrate.

2. The assembly as recited in claim 1 wherein the substrate comprises a spool and the Fiber Bragg Grating is in the middle of a length of optical fiber, the length of optical fiber being wound under tension around the spool at an expected maximum operating temperature for the Fiber Bragg Grating assembly with the ends of the optical fiber being securely attached to the spool.

3. The assembly as recited in claim 1 wherein the Fiber Bragg Grating is mounted linearly along the substrate and securely attached to the substrate along its entire at an expected minimum operating temperature for the Fiber Bragg Grating.

4. A method of thermally compensating a Fiber Bragg Grating assembly comprising the step of mounting a Fiber Bragg Grating on a substrate of a material having a very low coefficient of thermal expansion relative to that of the Fiber Bragg Grating such that the Fiber Bragg Grating is constrained to expand/contract at the very low coefficient of thermal expansion.

5. The method as recited in claim 4 wherein the mounting step comprises the steps of:
wrapping an optical fiber having the Fiber Bragg Grating somewhere in the middle around the substrate in the form of a spool at a maximum operating temperature for the Fiber Bragg Grating assembly; and
attaching the opposing ends of the optical fiber securely to the spool so that the optical fiber is constrained to expand/contract in accordance with the coefficient of thermal expansion of the spool.

6. The method as recited in claim 4 wherein the mounting step comprises the step of attaching the Fiber Bragg Grating securely along its length to the substrate at a minimum operating temperature for the Fiber Bragg Grating assembly.
